(19) United States
(12) Patent Application Publication
(10) Pub. No.: US 2010/0133259 A1
(43) Pub. Date: Jun. 3, 2010

(54) Heater usable with cooker, method of manufacturing the same and cooker

(75) Inventors: Ki Suk Jeon, Seongnam-si (KR); Jong Hak Hyun, Seoul (KR); John Chull Shon, Suwon-si (KR); Tae Woo Kim, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/461,588

(22) Filed: Aug. 17, 2009

(30) Foreign Application Priority Data
Dec. 2, 2008 (KR) 10-2008-121038

(51) Int. Cl. H05B 3/06

(52) U.S. Cl. 219/520; 219/546; 29/611

(57) ABSTRACT

Disclosed herein are a heater for cookers with high economical efficiency and improved performance, a method of manufacturing the same, and a cooker including the heater. The heater for cookers includes a heat-generator, and a heater body to house the heat-generator, a surface of the heater body having a prominence/depression pattern provided by surface-treating. The heater body is processed by sandblasting.

### CROSS-REFERENCE TO RELATED APPLICATIONS

This application claims the benefit of Korean Patent Application No. 2008-0121038, filed on Dec. 2, 2008 in the Korean Intellectual Property Office, the disclosure of which is incorporated herein by reference.

### BACKGROUND

1. Field

Embodiments of the present invention relate to a cooker, and a heater useful as a heat source of cookers.

2. Description of the Related Art

Cookers process or cook foods by heating. As a heat source to heat foods, a gas burner, electrical heater, etc. may be used.

Heaters generally used for cookers include sheath heaters, quartz heaters, halogen heaters and ceramic heaters, etc. These heaters have distinctive characteristics, advantages and disadvantages. Accordingly, taking into consideration various factors of respective heaters, such as physical properties, price, performance and installation structure, an optimum heater is applied.

For example, of these, ceramic heaters have relatively high far-infrared radiation efficiency and thus heat food from the inside and have properties suited to cook food, but have deteriorated economical efficiency due to high price. On the other hand, quartz heaters are inexpensive, but have low cooking efficiency due to lower far-infrared radiation efficiency.

### SUMMARY

Therefore, it is an aspect of the present embodiments to provide a heater for cookers with high economical efficiency and improved performance.

Additional aspects of the embodiments will be set forth in part in the description which follows and, in part, will be obvious from the description, or may be learned by practice of the invention.

The foregoing and/or other aspects are achieved by providing, a heater for cookers including: a heat-generator; and a heater body housing the heat-generator, the surface of the heater body having an irregular prominence/depression pattern provided by surface-treating.

The surface of the heater body may be processed by sandblasting.

The heater body may contain about 99% by weight or higher of silicon dioxide (SiO2).

The foregoing and/or other aspects are achieved by providing, a heater for cookers including: a heat-generator; and a quartz tube housing the heat-generator, the quartz tube having a sandblasted external surface.

The quartz tube may contain about 99% by weight or higher of silicon dioxide (SiO2).

The foregoing and/or other aspects are achieved by providing a method of manufacturing a heater for cookers including: preparing a quartz tube; processing an external surface of the quartz tube to impart a plurality of prominences/depressions to the external surface of the quartz tube; and arranging a heat-generator in the quartz tube.

The external surface of the quartz tube may be processed by sandblasting.

The foregoing and/or other aspects are achieved by providing a method of manufacturing a heater for cookers, including: preparing a quartz tube containing silicon dioxide (SiO₂); sandblasting an external surface of the quartz tube to form prominences/depressions on the external surface of the quartz tube; and providing a heat-generator in the quartz tube.

The quartz tube may contain about 99% or higher of silicon dioxide.

The silicon dioxide may have a purity of about 95% or higher.

The foregoing and/or other aspects are achieved by providing, a cooker including: a cooking area; and a heater to supply heat to the cooking area, the heater including a heater body having a heat-radiation surface to radiate heat to the cooking area and a heat-generator arranged in the heater body, the heat-radiation surface including a plurality of fine prominences/depressions.

The prominences/depressions may be formed by sandblasting.

The heater body may include a quartz tube containing about 99% by weight or higher of silicon dioxide (SiO2).

In accordance with the embodiments, material costs of the heater are reduced and cooking efficiency is improved.

### BRIEF DESCRIPTION OF THE DRAWINGS

These and/or other aspects and advantages will become apparent and more readily appreciated from the following description of the embodiments, taken in conjunction with the accompanying drawings of which:

FIGS. 1 and 2 are views illustrating an appearance and structure of a cooker according to one embodiment;

FIG. 3 is a perspective view illustrating a heater for a cooker according to one embodiment; and

FIG. 4 is a sectional view taken from the line I-I of FIG. 3.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

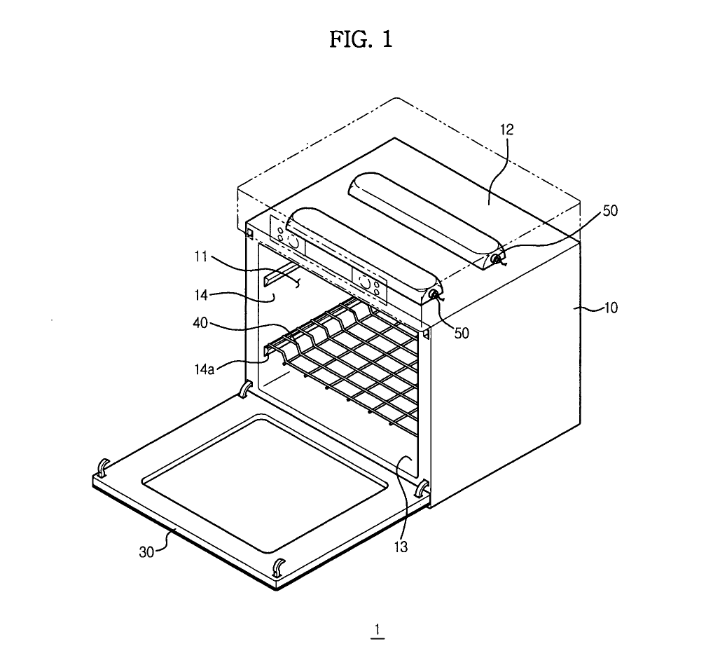

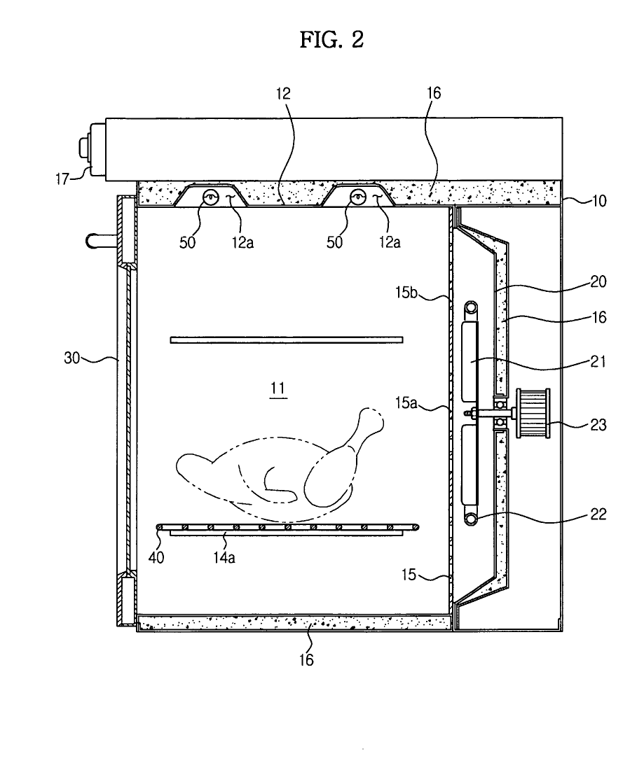

FIGS. 1 and 2 are views illustrating the appearance and structure of a cooker according to one embodiment.

As shown in FIGS. 1 and 2, a cooker 1 includes a housing 10 provided with a cooking area 11, and a door 30 hinge-bound to one side of the housing 10, to open or close an open front of the cooking area 11.

The cooking area 11 is defined by a top plate 12, a bottom plate 13, two side plates 14 and a rear plate 15 and constituent components of the cooker are provided in an area between the outside of the cooking area 11 and the housing 10.

The outside of the rear plate 15 is bound to a fan cover 20, and a convection fan 21 to circulate air through the cooking area 11 is provided interior the fan cover 20. A convection heater 22 is provided on the external circumference of the convection fan 21, and a fan motor 23, bound to the convection fan 21, is provided between the fan cover 20 and the rear plate 15 of the housing 10.

A plurality of inlet holes 15a, through which air enters the cooking area, are arranged on the center of the rear plate 15 facing the convection fan 21, and a plurality of outlet holes 15b, through which heat is supplied to the cooking area, are arranged more proximate to the edge of the rear plate 15.

Insulating members 16 may be arranged on the outside of the top plate 12, the bottom plate 13, the two side plates 14 and the fan cover 20 to define the cooking area 11, in order to insulate the cooking area 11 from the outside, and a control panel 17 to control the operation of an oven may be arranged on the top of the housing 10.

Meanwhile, a rail 14a to allow a rack 40 to be detachable is arranged on internal sides of the two side plates 14.

The cooker 1 includes at least one heater 50 as a heat source to radiation-heat food placed on the cooking area 11.

When food are placed on the rack 40 supported by the rail 14a, the door 30 is closed, and the control panel 17 is operated, the convection heater 22 heats and the convection fan 21 rotates via a fan motor 23. As a result, air in the cooking area 11 is absorbed through the inlet holes 15a, is heated through the convection heater 22, and is supplied through the outlet holes 15b to the cooking area 11, and the supplied hot air cooks food, while circulating within the inside of the cooking area 11. In addition, when the heater 50 for radiation heating is operated, the heater 50 directly radiation heats food in the cooking area 11. Upon cooking food, the convection heater 22 and the heater 50 for radiation heating operate together to heat food. Alternatively, one of the convection heater 22 and the radiation heater 50 may operate to heat food.

The radiation heater 50 may be arranged on the cooking area 11, and for the arrangement of the radiation heater 50, an accepting member 12a may be provided on the top plate 12 of the cooking area 11. Both ends of the heater 50 pass through the accepting member 12a, extend to the outside of the cooking area 11 and are connected to power outside the cooking area 11.

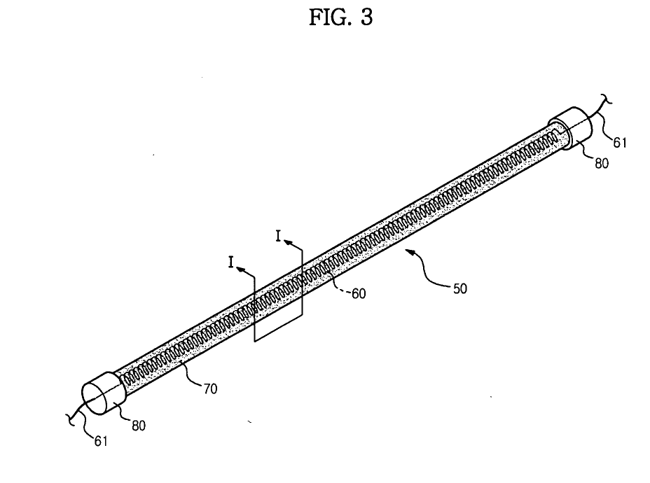

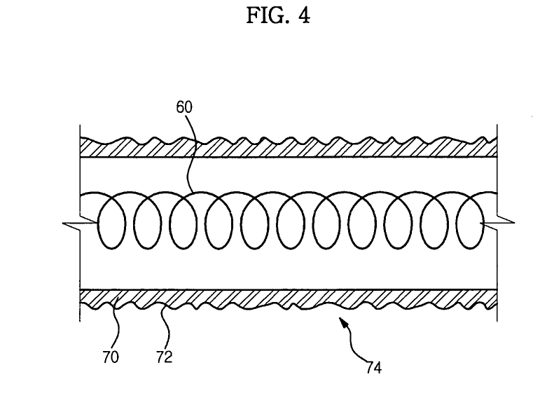

FIG. 3 is a perspective view illustrating a heater for a cooker according to one embodiment, and FIG. 4 is a sectional view taken from the line I-I of FIG. 3.

As shown in FIGS. 3 and 4, the heater 50 includes a heat-generator 60 to generate heat when power is applied thereto, and a heater body 70 to accept the heat-generator 60.

The heat-generator 60 may be made of a nickel-chromium wire or be in the form of a coil. A cap 80 is arranged on both ends of the heater body 70, and a lead wire 61 arranged on both ends of the heat-generator 60 passes through the cap 80 and extends to the outside of the heater body 70.

The heat-generator 60 heats the heater body 70 and the heated heater body 70 heats foods by emitting a variety of wavelengths. Infrared rays are electromagnetic waves whose wavelength is longer than a red region of ultraviolet rays. Far-infrared rays refer to infrared rays having a wavelength of about 3 μm or higher. Far-infrared rays are readily absorbed by materials, and suited to cooking of food due to high resonance activity thereof to organic compounds.

As shown in FIG. 4, the heater body 70 includes a heat-radiation surface 72 to radiate heat to the cooking area 11, and the heat-radiation surface 72 of the heater body 70 includes a plurality of prominences/depressions 74. The prominences/depressions 74 scatter near-infrared wavelength energy passing through the heater body 70 to convert the same into far-infrared wavelength energy and thereby to improve far-infrared radiation efficiency of the heater 50.

The prominences/depressions 74 of the heater body 70 may be finely formed by sandblasting. Sandblasting is a process in which fine sand is sprayed to a subject to be processed by a strong pressure to treat the surface of the subject. The use of sandblasting to process the heater body 70 enables control of the size of sand particles used to sandblast and thus determines optimal surface roughness of the heater body 70.

Depending on specifications of the heater 50, e.g., the type of metals used for the heat-generator 60, and the length or diameter of the heater body 70, the surface roughness of the heater body 70 to maximize far-infrared radiation efficiency may be varied. When the heater body 70 is processed by sandblasting, surface roughness is readily varied by simply controlling the size of sand particles used for processing, thus easily realizing optimal surface roughness according to heater specifications.

The heater body 70 may be provided in the form of a tube, and may be made of transparent quartz containing about 99% by weight or higher of silicon dioxide SiO2. The heater body 70 may be manufactured by melting silicon dioxide having a purity of about 95% or higher, followed by extrusion-molding.

Far-infrared ray radiation efficiency and radiation energy in a wavelength region of about 3 μm to 30 μm were measured for two specimens having the same size heated at 500° C. The results thus obtained are shown in Table 1 below. Specimen 1 is transparent quartz containing silicon dioxide having a purity of about 95% or higher, Specimen 2 is ceramic generally used for ceramic heaters, and Specimen 3 is transparent quartz, containing silicon dioxide having a purity of about 95% or higher, whose surface is sandblasted. The experiments were carried out at ambient temperature of approximately 20 to 22° C., and relative humidity of approximately 45 to 47%.

TABLE 1

| | Far-infrared ray radiation | Far-infrared ray radiation |
|---|---|---|
| | efficiency | efficiency (Watt/m²) |
| Specimen 1 | 0.673 | 124.642 × 10² |
| Specimen 2 | 0.700 | 129.482 × 10² |
| Specimen 3 | 0.698 | 124.129 × 10² |

As can be seen from Table 1 above, the far-infrared radiation efficiency of Specimen 3 corresponding to the embodiment is higher than that of non-surface-treated quartz (Specimen 1), and is comparable to that of Specimen 2.

Specimen 3 corresponding to the embodiment is cheaper than Specimen 2 and is thus more economical. The heater 50 according to the embodiment has advantages of both economical efficiency and performance.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A heater for cookers, comprising:
a heat-generator; and
a heater body housing the heat-generator, a surface of the heater body having an irregular prominence/depression pattern.

2. The heater according to claim 1, wherein the surface of the heater body is a sandblasted surface.

3. The heater according to claim 1, wherein the heater body contains about 99% by weight or higher of silicon dioxide (SiO₂).

4. A heater for cookers, comprising:
a heat-generator; and
a quartz tube housing the heat-generator, the quartz tube having a sandblasted external surface.

5. The heater according to claim 4, wherein the quartz tube contains about 99% by weight or higher of silicon dioxide (SiO₂).

6. A method of manufacturing a heater for cookers, comprising:
preparing a quartz tube;
processing an external surface of the quartz tube to impart a plurality of prominences/depressions to the external surface of the quartz tube; and
arranging a heat-generator in the quartz tube.

7. The method according to claim 6, wherein the external surface of the quartz tube is processed by sandblasting.

8. A method of manufacturing a heater for cookers, comprising:
preparing a quartz tube containing silicon dioxide (SiO₂);
sandblasting an external surface of the quartz tube to form prominences/depressions on the external surface of the quartz tube; and
providing a heat-generator in the quartz tube.

9. The method according to claim 8, wherein the quartz tube contains about 99% or higher of silicon dioxide.

10. The method according to claim 8, wherein the silicon dioxide has a purity of about 95% or higher.

11. A cooker, comprising:
a cooking area; and
a heater to supply heat to the cooking area, the heater including a heater body having a heat-radiation surface to radiate heat to the cooking area, the heat-radiation surface including a plurality of fine prominences/depressions; and
a heat-generator arranged in the heater body.

12. The cooker according to claim 11, wherein the heat-radiation surface is a sandblasted surface.

13. The cooker according to claim 11, wherein the heater body includes a quartz tube containing about 99% by weight or higher of silicon dioxide (SiO₂).
